(19) United States
(12) Patent Application Publication
(10) Pub. No.: US 2023/0008687 A1
(43) Pub. Date: Jan. 12, 2023

(54) SYSTEMS AND METHODS FOR SECURING DOORS WITH MAGNETIC LOCKS

(71) Applicant: PalatiumCare, Inc., Sheboygan, WI (US)

(72) Inventor: Joe Hasenstein, Sheboygan, WI (US)

(21) Appl. No.: 17/369,377

(22) Filed: Jul. 7, 2021

(51) Int. Cl. E05B 45/06; E05B 47/00

(52) U.S. Cl. CPC E05B 45/06; E05B 47/0038; E05B 2047/0054; E05B 2047/0068; E05B 2047/0076; E05B 2045/063; E05B 2045/069

(57) ABSTRACT

A magnetic lock assembly for a door includes a metal housing containing therein a magnet and a coil selectively energized to lock or unlock the door against an external armature plate. The magnetic lock further includes an audible alarm, a printed circuit board secured to an exterior surface of the metal housing and a cover made from a material that permits electromagnetic radiation to pass therethrough and positioned around the printed circuit board. The printed circuit board includes an electronic controller and a wireless communications interface configured to communicate wirelessly to a remote external system a signal indicating any one or more door conditions. These include propped door, delayed egress, forced door, insufficient bond, and door status indicating an open or closed status of the door.

### TECHNICAL FIELD

The present disclosure relates to systems and methods for securing doors with magnetic locks, and more specifically, to providing magnetic locks with different alarm modes.

### BACKGROUND

An electromagnetic lock or a magnetic lock is a locking device with an electromagnet and a metal plate. The electromagnetic lock uses magnetism to create a bond between the electromagnet and the metal plate. Some electromagnetic locks are rated between 600 to 1200 lbs. dynamic holding force. Some electromagnetic locks are fail-safe locks, meaning that once power is removed from the electromagnetic lock, the magnetic bond between the electromagnet and the metal plate relaxes and the door unlocks. Some electromagnetic locks are fail-secure, meaning that once power is removed from the electromagnetic lock, a latch of the electromagnetic locks keeps the electromagnetic lock locked. Electromagnetic locks typically have no moving parts, thus exhibiting fewer part failures.

### SUMMARY

According to some implementations of the present disclosure, a magnetic lock assembly for a door includes a metal housing containing therein a magnet and a coil selectively energized to lock or unlock the door against an external armature plate. The magnetic lock assembly further includes a printed circuit board secured to an exterior surface of the metal housing, and a cover made from a material that permits electromagnetic radiation to pass therethrough. The cover is positioned around the printed circuit board. The printed circuit board includes an electronic controller and a wireless communications interface operatively coupled to the electronic controller and configured to communicate wirelessly to a remote external system a signal indicating any one or more door conditions. These door conditions include: (a) propped door indicating that the door has been improperly propped open, (b) delayed egress indicating that a predetermined period of time has elapsed since at least a minimum force has been applied to the door, (c) forced door indicating that the door was opened without by means other than under control of the electronic controller, (d) insufficient bond indicating that the magnet is not fully bonded to the external armature plate, and (e) door status indicating an open or closed status of the door. The magnetic lock assembly further includes an audible alarm configured to output a tone sound or a tone pattern sound in response to any of at least some of the door conditions being satisfied.

The foregoing and additional aspects and implementations of the present disclosure will be apparent to those of ordinary skill in the art in view of the detailed description of various embodiments and/or implementations, which is made with reference to the drawings, a brief description of which is provided next.

### BRIEF DESCRIPTION OF THE DRAWINGS

The foregoing and other advantages of the present disclosure will become apparent upon reading the following detailed description and upon reference to the drawings.

FIG. 1 illustrates a perspective view of a magnetic lock assembly, according to some implementations of the present disclosure.

FIG. 2 illustrates components of the magnetic lock assembly of FIG. 1, according to some implementations of the present disclosure.

FIG. 3 illustrates a cross-sectional view for installing an armature plate on a door, according to some implementations of the present disclosure.

FIG. 4 illustrates a perspective view for installing a magnetic lock, according to some implementations of the present disclosure.

FIG. 5 illustrates alignment between a magnetic lock and an armature plate, according to some implementations of the present disclosure.

FIG. 6 illustrates a printed circuit board for magnetic lock assemblies, according to some implementations of the present disclosure.

FIG. 7 illustrates a block diagram of a magnetic lock system, according to some implementations of the present disclosure.

While the present disclosure is susceptible to various modifications and alternative forms, specific implementations have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the present disclosure as defined by the appended claims.

### DETAILED DESCRIPTION

Embodiments of the present disclosure provide a magnetic lock assembly that supports a delayed egress for securing locking and delayed release of emergency exit and perimeter doors. The magnetic lock assembly can be used in hospitals, group homes, retirement homes, etc. The magnetic lock assembly is self-contained and compatible with existing doors and latching hardware. The magnetic lock assembly includes all electronics built in, allowing ease of installation and wiring.

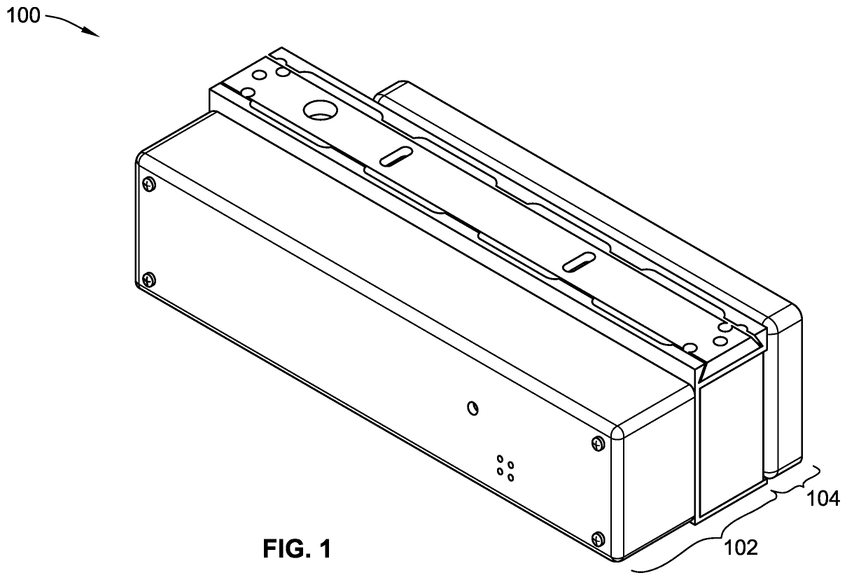

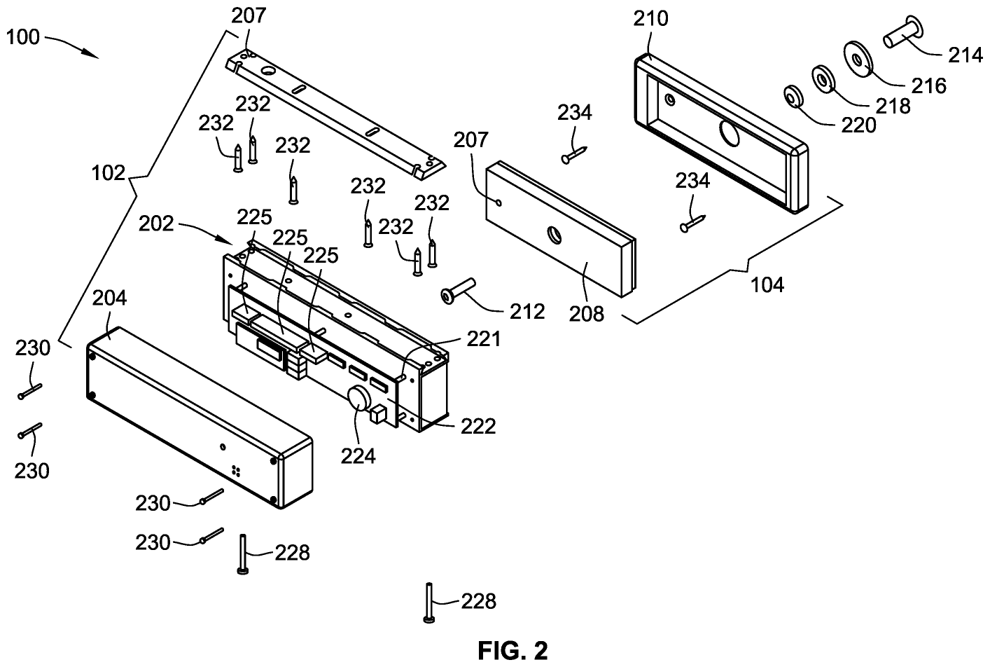

FIG. 1 illustrates a perspective view of a magnetic lock assembly 100, according to some implementations of the present disclosure. The magnetic lock assembly 100 includes a lock portion 102 and an armature portion 104. The armature portion 104 is preferably attached to a door, and the lock portion 102 is preferably attached to a door frame. In an implementation, the lock portion 102 has dimensions of about 3¼″×3″×10½″. In an implementation, the armature portion 104 has dimensions of about 1″×2⅝″×8⅝″. The magnetic lock assembly 100 can weigh about 10 lbs with a holding force of over about 1000 lbs. FIG. 2 illustrates components of the magnetic lock assembly 100, according to some implementations of the present disclosure. The lock portion 102 of the magnetic lock assembly 100 includes a lock 202. The lock 202 includes a metal housing containing therein a magnet (not shown) and a coil (not shown). The metal housing can be anodized brushed aluminum and nickel plated steel. The coil is selectively energized to lock or unlock a door to which the armature portion 104 is attached. The lock portion 102 further includes a mounting bracket 206 that interfaces with the lock 202 to secure the lock 202 to the door frame. In some implementations, the mounting bracket 206 is secured to the door frame using screws 232, and the lock 202 slides along the major axis of the mounting bracket 206 to clasp the lock 202 to the mounting bracket 206. The screws 228 can be used to prevent the lock 202 from dislodging from the mounting bracket 206.

The lock portion 102 of the magnetic lock assembly 100 further includes a printed circuit board 222 secured to an exterior surface of the metal housing of the lock 202. In some implementations, the printed circuit board 222 is mounted to the lock 202 using rods 221 such that there is a separation between the printed circuit board 222 and the lock 202. In some implementations, the separation between the printed circuit board 222 and the lock 202 can be used for routing wires to and from the printed circuit board 222. The printed circuit board 222 includes an electronic controller (not shown), a wireless communications card 226, a buzzer 222, one or more connectors 225. The lock portion 102 further includes a cover 204 for protecting the printed circuit board 222. The cover 204 is secured to the lock 202 using screws 230. The cover 204 is made from a material that permits electromagnetic radiation to pass through. The wireless communication card 226 should be able to provide signals to remote systems and not be shielded, hence the cover 204 is not made of metal that can shield electromagnetic radiation. The cover 204 can be a plastic cover.

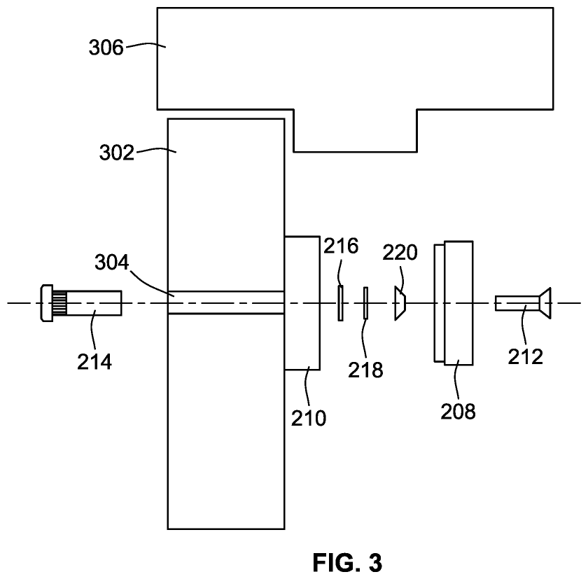

The armature portion 104 (FIG. 1) is preferably attached to the door, and the lock portion 102 (FIG. 1) is preferably attached to the door frame. Assembly of the armature portion 104 (FIG. 2) will be described in connection with FIG. 3. FIG. 3 illustrates a cross-sectional view for installing an armature plate 208 on a door 302, according to some implementations of the present disclosure. An armature plate holder 210 is attached to the door 302 using screws 234. The armature plate holder 210 is configured to receive the armature plate 208. A cone washer 220, a flat washer 218, a silicone washer 216, or any combination thereof, can be used between the armature plate holder 210 and the armature plate 208. An armature bolt 212 secures the armature plate 208 to the armature plate holder 210. The armature bolt 212 is long enough to protrude through the armature plate holder 210 and into a drilled hole 304 into the door 302. A sex bolt 214 is inserted in an opposite opening of the drilled hole 304 for receiving the armature bolt 212. Once the armature bolt 212 is tightened to the sex bolt 214, the armature portion 104 (FIG. 2) is assembled onto the door 302. The lock portion 102 (FIG. 2) when assembled will be secured to a door frame 306. The armature plate 208 can have a spring release 207 (FIG. 2) in some implementations.

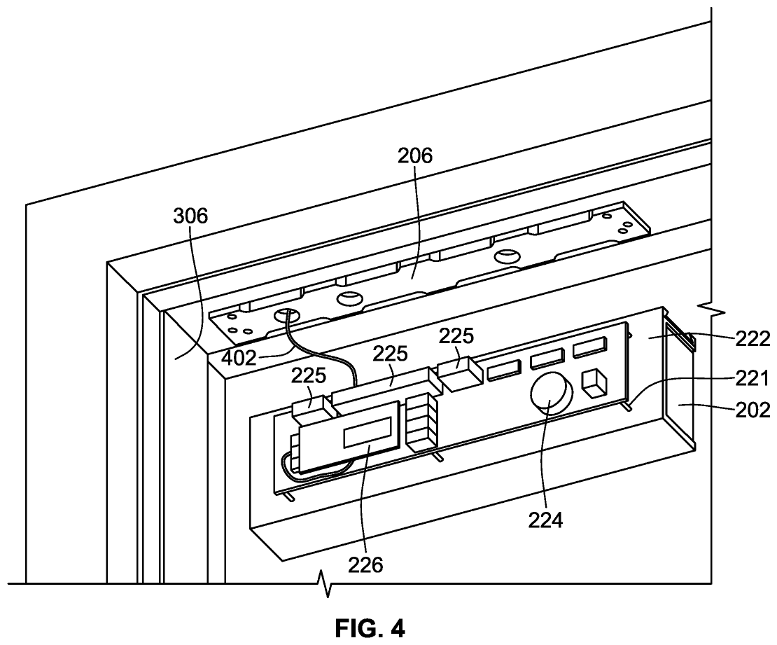

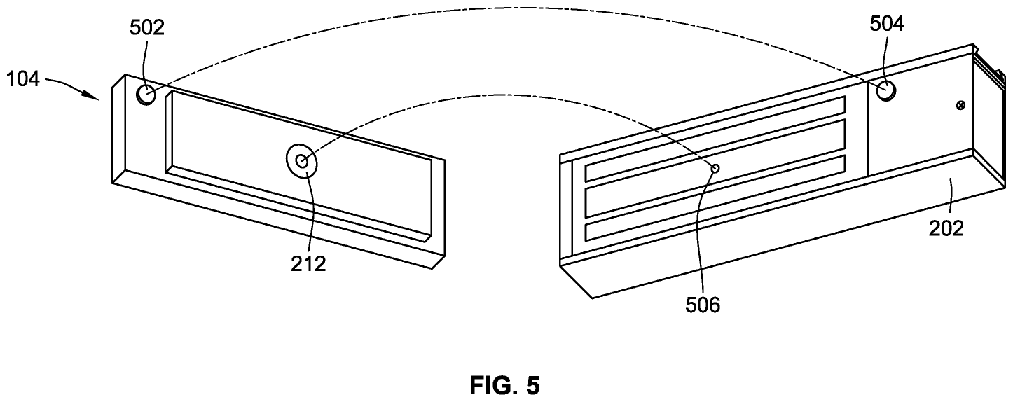

FIG. 4 illustrates a perspective view for installing the lock 202 to the door frame 306, according to some implementations of the present disclosure. The door frame 306 can include paths for electrical wires (e.g., wire 402) so that the lock 202 and the printed circuit board 222 can be wired to external systems (e.g., power supplies, fire alarms, security systems, etc.). Installing the lock 202 and the armature plate 208 (FIG. 3) on the door frame 306 and the door 302 (FIG. 3), respectively, can result in misalignment between the lock 202 and the armature plate 208. FIG. 5 illustrates alignment between the lock 202 and the armature plate 208, according to some implementations of the present disclosure. In some implementations, the armature portion 104 includes a small magnet 502. The lock 202 can include a magnet sensor 504 (e.g., < >) such that when the armature portion 104 is aligned with the lock 202, the magnet sensor 504 senses the small magnet 502 placed in the armature plate holder 210. The lock 202 includes a plunger 506. The plunger 506 is aligned to the armature bolt 212. The plunger 506 facilitates delayed egress such that when the magnet inside the lock 202 is disengaged, the plunger 506 delays the door 302 opening for a moment in time.

The magnetic lock assembly 100 (FIG. 1) can be installed on doors requiring alarm notification and control. The magnetic lock assembly 100 can secure and release perimeter and emergency exit doors. Installing the magnetic lock assembly 100 is similar to installing standard magnetic locks by using a 2 wire connection to a local UL294 listed 12 or 24 VDC power source, a 2 wire connection to a fire alarm control panel, 2 wire connection to an auxiliary activation device, and a 2 wire or 4 wire connection to a control device (e.g., keypad or access control system).

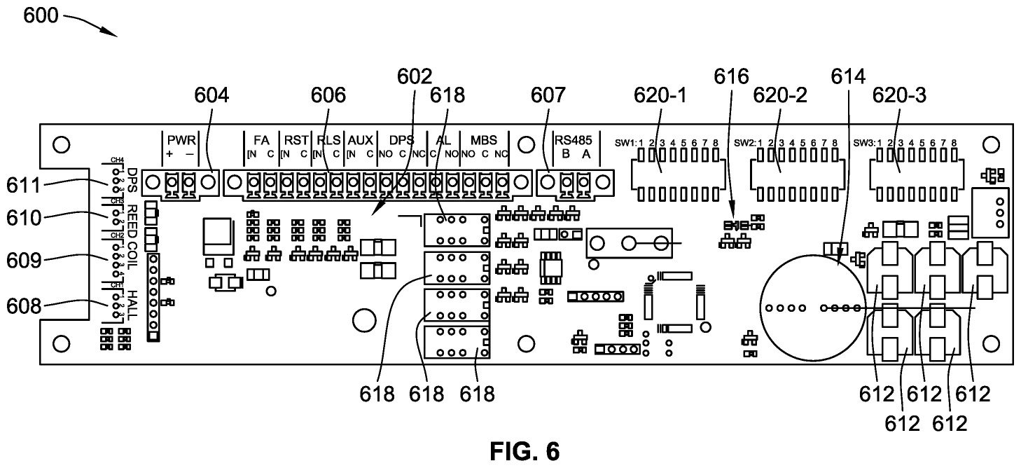

FIG. 6 illustrates a printed circuit board 600 for magnetic lock assemblies (e.g., the magnetic lock assembly 100 of FIG. 1), according to some implementations of the present disclosure. The printed circuit board 600 includes a wireless communications interface 602. In some implementations, the wireless communications interface 602 is EN1941 wireless module. The printed circuit board 600 includes a power connector 604 for receiving a power input for the board. The printed circuit board 600 can include a wide connector 606 and an RS485 connector 607. The RS485 connector 607 is provided as an example data bus, but in some implementations, an Ethernet or some other wired communications connector is provided on the printed circuit board 600. The wide connector 606 can be used for different signals used by the magnetic lock assembly 100. The different signals can include a fire alarm input signal (FA), a reset input signal (RST), a release input signal (RLS), an auxiliary delayed egress trigger input (AUX), a door position switch output (DPS), an alarm output (AL), a magnetic bond sensor output (MBS), or any combination thereof.

The printed circuit board 600 can include one or more electrical connections. For example, an integrated device power supply connection 611, a reed switch connection 610, a coil connection 609, a hall sensor connection 608, or any combination thereof. The printed circuit board 600 can include one or more relays 618 and one or more switches 620-1, 620-2, and 620-3. In an implementation, the one or more switches 620-1, 620-2, and 620-3 are dual in-line package (DIP) switches. The printed circuit board 600 can include status indicators (e.g., light emitting diode 616 for visual indication and a buzzer 614 for audial indication). In the case of loss of power, the printed circuit board 600 can rely on a capacitor bank 612 for temporarily powering the wireless communications interface 602 to prevent data loss during wireless data transmission of a status of the magnetic lock assembly 100 (FIG. 1). The wireless communications interface 602 can be a wireless transmitter, a wireless receiver, or both. The light emitting diode 616 and/or the buzzer 614 can be used to indicate a plurality of operating conditions. Examples of operating conditions include locked door condition, unlocked door condition, propped door condition, nuisance delay timer, delayed egress timer, delayed egress alarm, nuisance delay alarm, fire alarm, etc.

The signaling of the printed circuit board 600 of FIG. 6 will be described in context of the magnetic lock assembly 100 of FIGS. 1-2. Under normal locked conditions for the magnetic lock assembly 100, the lock 202 will magnetically hold the armature plate 208 secure, and the light emitting diode 616 (FIG. 6) will show a red light. When the lock 202 is unlocked by closing the release input signal RLS of the wide connector 606, the lock 202 will release the armature plate 208. The light emitting diode 616 will show a green light.

In an implementation, if the magnetic lock assembly 100 loses power, the lock 202 will release the armature plate 208 when in a fail-safe configuration. The light emitting diode 616 will lose power and not show any light.

In an implementation, while the magnetic lock assembly 100 is in a locked position, when someone pushes on the door to which the magnetic lock assembly 100 is attached, the door may move slightly outward. In an implementation, the push needs to exceed a threshold outward force for the door to move slightly outward. The threshold outward force can be 10 lbs, 15 lbs, 20 lbs, etc. The slightly outward move of the door can cause the armature bolt 212 to recess into the armature plate 208, thus allowing a delayed egress switch (e.g., the switch 620-2) to be activated. Once the delayed egress switch is activated, an alarm can begin to sound (e.g., an alarm from the buzzer 614). The light emitting diode 616 can begin to flash indicating the delayed egress switch is activated. In an implementation, after a nuisance delay, the lock 202 enters a delayed egress cycle. The nuisance delay is amount of time the door must be pushed or auxiliary inputs must be pressed before triggering the delayed egress cycle. The nuisance delay can last for about 0 to 3 seconds, with the exact duration being programmable. In an implementation, the switch 620-1 can set the nuisance delay as 0 seconds, 1 second, 2 second, or 3 second. In an implementation, nuisance delay is set in an electronic memory (e.g., a random access memory or a read only memory). 0 to 3 seconds are provided as examples, other durations can be set in the electronic memory, for example, 5 seconds, 7 seconds, 10 seconds, etc. 0 to 3 seconds is preferable in case of emergency exits.

Similar to the nuisance delay, the delayed egress cycle can last for about 15 or 30 seconds, with the exact duration being programmable. An electronic memory or a DIP switch can be used to set duration of the delayed egress cycle. If the duration of the delayed egress cycle is set at 0, then the delayed egress cycle does not occur. In an implementation, once past the nuisance delay, the delayed egress cycle cannot be canceled by no longer pushing on the door (i.e., by releasing pressure on the door). The delayed egress cycle will continue until completion and then release the magnet in the lock 202. When the lock 202 releases after the delayed egress cycle, the light emitting diode 616 continues flashing and the buzzer 614 continuously sounds the alarm until reset.

In an implementation, in case of a fire alarm or loss of power, the lock 202 immediately releases the armature plate 208 automatically. Whenever power is removed from the lock 202 and then re-applied, the lock 202 can be configured to remain unlocked and non-functional until the reset input signal RST is shorted. Keeping the door unlocked after power loss and power returning prevents the door from automatically re-locking. This behavior is in compliance with many interpretations of International Building Code (IBC) standards. In some implementations, this behavior can be bypassed. For example, the switch 620-1 can be set such that the door is auto re-locked upon regain of power. In an implementation, the switch 620-2 can set a duration or delay until re-locking. For example, the switch 620-2 is a DIP switch with 8 switches. Four of the switches can be used to program the delay until re-locking.

In an implementation, the switch 620-1 can be used to set anti-tailgate settings. Anti-tailgate being activated means that once the door is opened, the door re-locks immediately after closing, regardless of whether a re-lock time delay has elapsed. In an implementation, the switch 620-1 can be used to set whether an alarm should sound when the door is propped open or when the door is forced open. The switch 620-2 can be used to set the duration for alarm when the door is propped open. For example, the switch 620-2 can be set to 150 seconds so that the alarm sounds after 150 seconds. In an implementation, the switch 620-1 can be used to set whether a sound or horn should sound when the door is unlocked and power is still applied to the door. In an implementation, the switch 620-1 can be used to enable or disable the plunger 506.

The printed circuit board 600 includes an input for receiving incoming fire alarm signal indicative of a fire alarm from an external fire sensing system. The wide connector 606 can include fire alarm input FA for receiving the incoming fire alarm signal. The electronic controller causes the wireless communications interface 602 to communicate to a remote external system an outgoing fire alarm signal indicating that the fire alarm has been triggered. The electronic controller can cause the magnet to become de-energized to unlock the door in response to receiving the incoming fire alarm signal. In some implementations, the lock 202 becomes unlocked and allows egress during an emergency.

In an implementation, the lock 202 can be released using a keypad, a push button, or a keyed kill-switch to cause a momentary switch opening across the release input RLS. In an implementation, the alarm buzzing from the buzzer 614 can be reset using the keypad, the push button, or the keyed kill-switch to cause a memory switch opening across the reset input RST and/or the release input RLS. Disconnecting or breaking the power to the lock 202 can lease the lock 202 or reset the alarm buzzing from the buzzer 614. In some implementations, a wireless card (e.g., a radio frequency identification) or low power wireless transmitter can disturb electromagnetic field around the wireless communications module 614. For example, once the wireless communications module 614 senses the wireless card or the low power wireless transmitter, the person carrying the wireless card or the low power wireless transmitter is authenticated and the magnet in the lock 202 can become de-energized to unlock the door. In some implementations, the person carrying the wireless card or low power wireless transmitter employs a short range wireless data exchange having a transmission range of at least 33 feet.

The printed circuit board 600 can include the capacitor bank 612 for temporarily providing power to the lock 202 when the lock 202 loses power. The capacitor bank 612 can provide power to the wireless communications interface 614 for at least a time corresponding to an amount of time for wirelessly communicating signals to a remote external system. In some implementations, when the capacitor bank 612 is used to provide power to the wireless communications interface 614, the electronic controller provides a signal for de-energizing the magnet in the lock 202 to unlock the door. The signals that can be communicated by the wireless communications interface 614 include a door status indicating an open or closed status of the door, insufficient bond indicating that the magnet of the lock 202 is not fully bonded to the armature plate 208, a forced door indicating that the door was opened by means other than under control of the electronic controller, delayed egress indicating that a nuisance delay has elapsed, propped door status indicating that the door has been improperly propped open, etc.

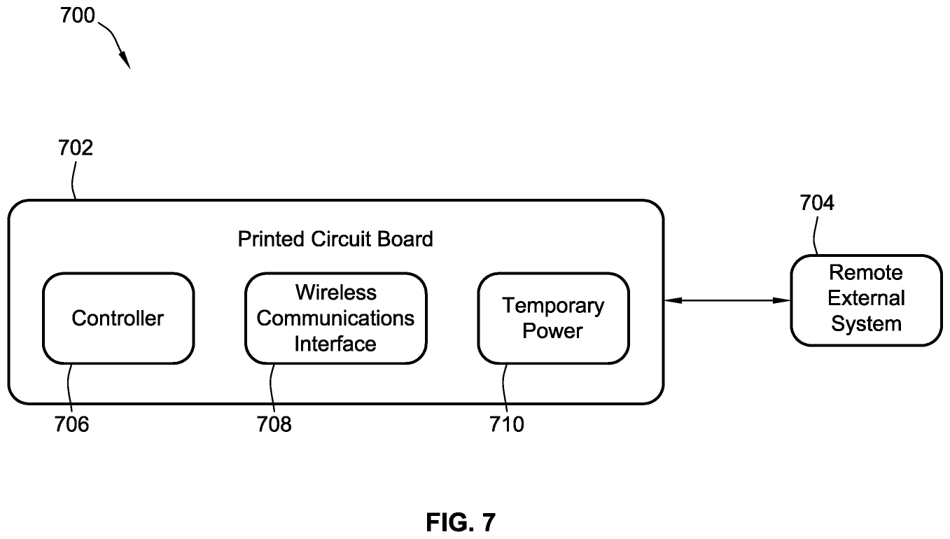

FIG. 7 illustrates a block diagram of a magnetic lock system 700, according to some implementations of the present disclosure. The magnetic lock system 700 includes a printed circuit board 702 which is similar to or the same as the printed circuit board 600 or the printed circuit board 222. The printed circuit board 702 includes an electronic controller 706, a wireless communications interface 708 (similar to or the same as the wireless communications interface 614), and temporary power 710 (e.g., the capacitor bank 612). The magnetic lock system 700 can communicate with remote external systems 704. These can include fire alarm systems, security systems, etc.

According to some embodiments of the present disclosure, processes described above with reference to operations of the electronic controller or other computerized electronic systems may be implemented in a computer software program. For example, some embodiments of the present disclosure include a computer program product, which includes a computer program that is carried in a computer readable medium. The computer program includes program codes. The computer program may be downloaded and installed from a network (e.g., the Internet, a local network, etc.) and/or may be installed from a removable medium (e.g., a removable hard drive, a flash drive, an external drive, etc.). The computer program, when executed by a central processing unit or the electronic controller above implements the above described functions provided herein in the present disclosure.

A computer readable medium according to the present disclosure may be a computer readable signal medium or a computer readable storage medium or any combination of the above two. Examples of the computer readable storage medium may include electric, magnetic, optical, electromagnetic, infrared, or semiconductor systems, elements, apparatuses, or a combination of any of the above. More specific examples of the computer readable storage medium include a portable computer disk, a hard disk, a random access memory (RAM), a read only memory (ROM), an erasable programmable read only memory (EPROM or flash memory), an optical fiber, a portable compact disk read only memory (CD-ROM), an optical memory, a magnetic memory, or any suitable combination of the above.

The computer readable storage medium according to some embodiments may be any tangible medium containing or storing programs, which may be used by, or used in combination with, a command execution system, apparatus or element. In some embodiments of the present disclosure, the computer readable signal medium may include a data signal in the base band or propagating as a part of a carrier wave, in which computer readable program codes are carried. The propagating data signal may take various forms, including but not limited to an electromagnetic signal, an optical signal, or any suitable combination of the above. The computer readable signal medium may also be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium, including but not limited to: wireless, wired, optical cable, RF medium, etc., or any suitable combination of the above.

A computer program code for executing operations in the present disclosure may be compiled using one or more programming languages or combinations thereof. The programming languages include object-oriented programming languages, such as Java or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or electronic device. In the circumstance involving a remote computer, the remote computer may be connected to a user's computer through any network, including local area network (LAN) or wide area network (WAN), or be connected to an external computer (for example, connected through the Internet using an Internet service provider).

The flow charts and block diagrams in the accompanying drawings illustrate architectures, functions and operations that may be implemented according to the systems, methods and computer program products of the various embodiments of the present disclosure. Each of the blocks in the flow charts or block diagrams may represent a program segment or code that includes one or more executable instructions for implementing specified logical functions. It should be further noted that, in some alternative implementations, the functions denoted by the flow charts and block diagrams may also occur in a sequence different from the sequences shown in the figures. For example, any two blocks presented in succession may be executed substantially in parallel, or sometimes be executed in a reverse sequence, depending on the functions involved. It should be further noted that each block in the block diagrams and/or flow charts as well as a combination of blocks in the block diagrams and/or flow charts may be implemented using a dedicated hardware-based system executing specified functions or operations, or by a combination of dedicated hardware and computer instructions.

While the present disclosure has been described with reference to one or more particular implementations, those skilled in the art will recognize that many changes may be made thereto without departing from the spirit and scope of the present disclosure. Each of these embodiments and implementations and obvious variations thereof is contemplated as falling within the spirit and scope of the present disclosure, which is set forth in the claims that follow.

What is claimed is:

1. A magnetic lock assembly for a door, comprising:
a metal housing containing therein a magnet and a coil selectively energized to lock or unlock the door against an external armature plate;
a printed circuit board secured to an exterior surface of the metal housing;
a cover made from a material that permits electromagnetic radiation to pass therethrough, the cover being positioned around the printed circuit board;
the printed circuit board including an electronic controller and a wireless communications interface operatively coupled to the electronic controller and configured to communicate wirelessly to a remote external system a signal indicating any one or more of the following door conditions:
propped door indicating that the door has been improperly propped open,
delayed egress indicating that a predetermined period of time has elapsed since at least a minimum force has been applied to the door,
forced door indicating that the door was opened without by means other than under control of the electronic controller,
insufficient bond indicating that the magnet is not fully bonded to the external armature plate, and
door status indicating an open or closed status of the door; and
the assembly further comprising an audible alarm configured to output a tone sound or a tone pattern sound in response to any of at least some of the door conditions being satisfied.

2. The assembly of claim 1, the printed circuit board further comprising a first input configured to receive an incoming fire alarm signal indicative of a fire alarm from an external fire sensing system, and responsive thereto, the electronic controller causing the wireless communications interface to communicate to the remote external system an outgoing fire alarm signal indicating that the fire alarm has been triggered.

3. The assembly of claim 2, wherein the electronic controller is further configured to, in response to receiving the incoming fire alarm signal, cause the magnet to become de-energized to thereby unlock the door and allow egress during an emergency.

4. The assembly of claim 1, wherein the wireless communications interface includes a wireless transmitter, a wireless receiver, or both.

5. The assembly of claim 4, wherein the wireless communications interface includes the wireless transmitter and the wireless receiver, wherein the electronic controller is further configured to detect identification information associated with a person carrying or wearing a low power wireless transmitter, and, responsive to authenticating the identification information, cause the magnet to become de-energized to thereby unlock the door.

6. The assembly of claim 5, wherein the low power wireless transmitter carried by the person employs a short range wireless data exchange having a transmission range of at least 33 feet.

7. The assembly of claim 1, wherein the printed circuit board includes a capacitor bank having collectively an energy capacity to provide power to the wireless communications interface for at least a time corresponding to an amount of time to wirelessly communicate the signal to the remote external system.

8. The assembly of claim 7, wherein the assembly is fail-safe upon a loss of external power to the printed circuit board.

9. The assembly of claim 8, wherein the electronic controller, using power from the capacitor bank, causes the magnet to become de-energized to thereby unlock the door responsive to a loss of external power to the printed circuit board.

10. The assembly of claim 1, wherein the printed circuit board further includes a plurality of switches configured to change one or more settings of the magnetic lock assembly.

11. The assembly of claim 10, wherein the settings include:
nuisance delay period indicating an amount of time the door must be pressed or an external auxiliary input must be pressed to trigger a delayed egress cycle,
nuisance alert indicating whether to sound the audible alarm during the nuisance delay period,
auto re-lock indicating whether the magnet should be re-energized to thereby lock the door responsive to regaining power following a loss of power to the circuit board or responsive to clearing a fire alarm condition,
anti-tailgate indicating whether the magnet should be re-energized to thereby lock the door after the door closes,
door propped or door forced alarm indicating whether to enable the audible alarm responsive to a propped door or forced door condition,
unlock alert indicating whether to sound the audible alarm responsive to the door being unlocked while external power is still applied to the magnet,
internal delayed egress indicating whether to delay unlocking of the door.

12. The assembly of claim 1, wherein the assembly including the metal housing and the cover has overall dimensions that do not exceed 4 inches in width, 4 inches in depth, and 12 inches in length.

13. The assembly of claim 1, wherein the printed circuit board further includes one or more light emitting diodes (LED) configured to provide a visual indication of one of a plurality of operating conditions of the magnetic lock assembly.

14. The assembly of claim 13, wherein the plurality of operating conditions includes one of locked, unlocked, propped door condition, nuisance delay timer, delayed egress timer, delayed egress alarm, or fire alarm.

15. The assembly of claim 1, further comprising a power supply connector configured to receive external power to provide power to the magnet and to the printed circuit board.
